(19) United States
(12) Patent Application Publication
(10) Pub. No.: US 2018/0005258 A1
(43) Pub. Date: Jan. 4, 2018

(54) SYSTEM AND METHOD FOR PROVIDING A DISCOUNT ON THE PURCHASE OF GASOLINE

(71) Applicant: EDWARD PULLEY, SCOTTSDALE, AZ (US)

(72) Inventor: EDWARD PULLEY, SCOTTSDALE, AZ (US)

(21) Appl. No.: 15/356,284

(22) Filed: Nov. 18, 2016

Related U.S. Application Data
(60) Provisional application No. 62/357,264, filed on Jun. 30, 2016.

(51) Int. Cl. G06Q 30/02; G06Q 20/10

(52) U.S. Cl. CPC G06Q 30/0226; G06Q 30/0269; G06Q 20/102; G06Q 30/0239

(57) ABSTRACT

A method of providing a discount on fuel purchases comprising: registering for a membership program account, the membership program account having a fee for a predetermined timeframe, the fee allowing an individual to purchase up to a maximum volume of fuel at a discounted rate for the timeframe; issuing a bank card to the individual; inserting the bank card in a fueling pump of a fueling station; charging the bank card for the amount purchased; and crediting the membership program account of the individual a predetermined amount for every gallon of fuel purchased during the timeframe that does not exceed the maximum volume, wherein the crediting is paid through the fee and membership sponsors.

### TECHNICAL FIELD

The present application in general relates to membership services, and more specifically, to a membership service which allows customers to obtain a discount on the purchase of gasoline from any gasoline provider.

### BACKGROUND

There are various types of membership programs available today. One example is a membership wholesale or warehouse club such as Costco and Sam's Club. Membership warehouse clubs enjoy certain competitive advantages that generally are not available to traditional retailers. These advantages enable warehouse clubs to offer very low prices. In addition to attracting new customers, this encourages existing customers to shift more of their purchasing from traditional retailers to warehouse clubs. A warehouse club is able to maintain low prices by (a) generating high sales volumes, (b) charging membership fees, and (c) stocking an inventory of goods covering a wide array of product categories (though a relatively low number of stock-keeping units, or SKUs).

Another type of membership programs are rewards/loyalty programs. Many retailers, such as supermarkets, discount stores, warehouse stores or clubs, convenience stores and the like, have programs in which customers are provided with cards, sometimes referred to as frequent shopper cards or loyalty cards, which enable the customers to receive discounts on selected products or other awards if the card is presented (and typically scanned) at the time of purchase. Such cards typically have customer identifying information encoded thereon, such as in the form of an optically readable bar code or some other machine readable form, which link the customer and the card to a particular account and/or record associated with the customer.

Many such retailers, in addition to offering their traditional products (e.g., food and household items), also sell gasoline. When purchasing gasoline from the retailer, the customer may receive a discount on the gasoline purchase. However, the discount provided is generally related to the amount of groceries and/or other products the customer had previously purchased from the retailer. For example, a grocery store's reward program may give the customer one point for every dollar spent. Once the customer has reached a certain point level, the customer may receive a discount off per gallon of gas purchased up to a predefined number of gallons. As an example, once the customer spends $100 with the retailer, the customer may receive 10 cents off per gallon up to 30 gallons.

There are several problems with the above programs. First, most discounts are only given at the retailer's gas station. The discounts are not applicable at other gas stations which may be selling gas at a cheaper price per gallon. Second, the discount given is generally based on the amount of groceries and/or other products the customer had previously purchased from the retailer and most discounts are capped at predefined number of gallons.

Therefore, it would be desirable to provide a system and method that overcomes the above. The membership program would provide a set discount off gasoline purchases at any gas station.

### SUMMARY

In accordance with one embodiment, a method of providing a discount on fuel purchases is disclosed. The method comprising: registering for a membership program account, the membership program account having a fee for a predetermined timeframe, the fee allowing an individual to purchase up to a maximum volume of fuel at a discounted rate for the timeframe; issuing a bank card to the individual; inserting the bank card in a fueling pump of a fueling station; charging the bank card for the amount purchased; and crediting the membership program account of the individual a predetermined amount for every gallon of fuel purchased during the timeframe that does not exceed the maximum volume, wherein the crediting is paid through the fee and membership sponsors.

In accordance with one embodiment, a method of providing a discount on fuel purchases is disclosed. The method comprising: registering for a membership program account, the membership program account having a fee for a predetermined timeframe, the fee allowing an individual to purchase up to a maximum volume of fuel at a discounted rate for the timeframe; filling out a questionnaire by the individual, the questionnaire providing details to allow direct marketing to the individual by membership sponsors; issuing a bank card to the individual; inserting the bank card in a fueling pump of a fueling station; charging the bank card for the amount purchased; paying the fueling station the amount purchased; and crediting the membership program account of the individual a predetermined amount for every gallon of fuel purchased during the timeframe that does not exceed the maximum volume, wherein the crediting is paid through the fee and membership sponsors.

In accordance with one embodiment, a method of providing a discount on fuel purchases is disclosed. The method comprising: registering for a membership program account, the membership program account having a fee for a predetermined timeframe, the fee allowing an individual to purchase up to a maximum volume of fuel at a discounted rate for the timeframe; filling out a questionnaire by the individual, the questionnaire providing details to allow direct marketing to the individual by membership sponsors; signing up the membership sponsors by providing the membership sponsors with detailed profiles of individuals for targeted marketing, wherein each membership sponsor pays a fee to receive the detailed profiles; setting up web pages by at least one of the membership sponsors to show special offers by the membership sponsors; issuing a bank card to the individual; inserting the bank card in a fueling pump of a fueling station; charging the bank card for the amount purchased; paying the fueling station the amount purchased; and crediting the membership program account of the individual a predetermined amount for every gallon of fuel purchased during the timeframe that does not exceed the maximum volume, wherein the crediting is paid through the fee and membership sponsors.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a diagram of an exemplary membership service system which allows customers to obtain a discount on the purchase of gasoline from any gasoline provider

FIG. 2 is a simplified block diagram showing an illustrative server/computing device depicted in FIG. 1 in accordance with one aspect of the present application; and

FIG. 3 is a simplified block diagram showing operation of the membership service system depicted in FIG. 1 according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

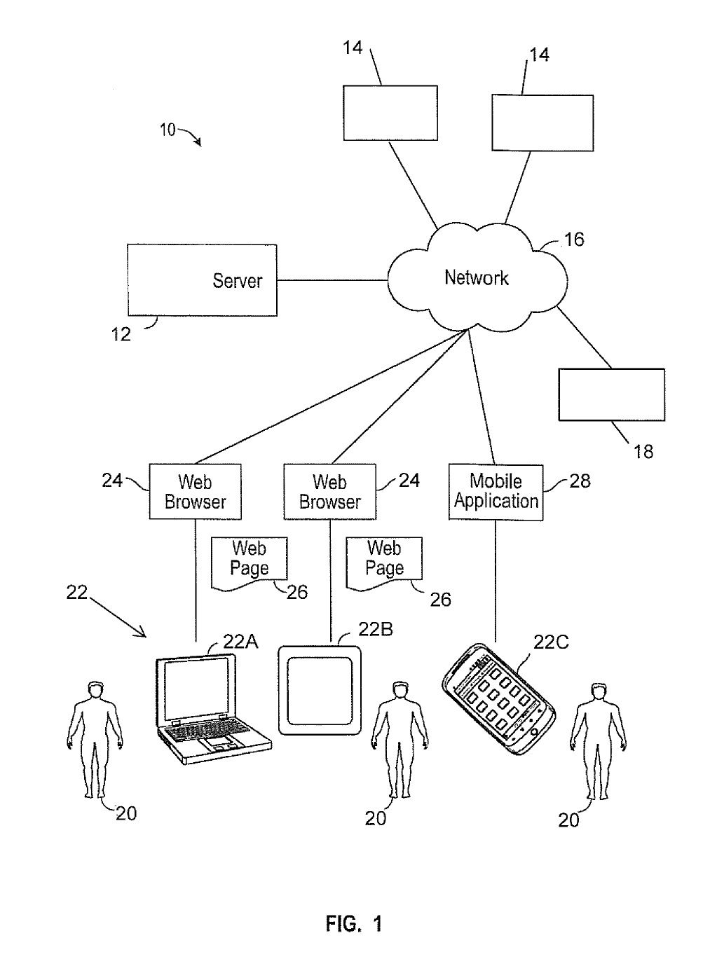

Referring now to FIG. 1, a membership system 10 (system 10) may be shown. The system 10 may allow a customer to sign up and receive a set discount off of gasoline purchases. The membership program would allow the customer to go to any gas station to receive the discount. The discount would be a set discount per gallon of gas and would not be related to the amount of groceries and/or other products the customer had previously purchased. The components of the system 10 may be coupled through wired or wireless connections.

The system 10 may have a membership program server 12. The membership program server 12 may be used to host the membership program of the present invention. One or more other financial service provider servers 14 may be coupled to the membership program server 12 via a network 16. The financial service provider servers 14 may be used to process transactions between the gasoline station 18, a customer's account with the financial service provider and the membership program server 12. The network 16 may be a local area network (LAN), a general wide area network (WAN), wireless local area network (WLAN) and/or a public network

Individuals 20 may use one or more computing devices 22 to access the membership program server 12. The computing devices 22 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 22 may be described in the general context of computer system executable instructions, such as program modules, being executed by a computer system as may be described below. In the embodiment shown in FIG. 1, the computing device 22 may be seen as a desktop/laptop computing system 22A, a tablet device 22B and a mobile phone device 22C. However, this should not be seen in a limiting manner as any computing device 22 described above may be used.

The computing devices 22 may be loaded with an operating system. The operating system of the computing device 22 may manage hardware and software resources of the computing device 22 and provide common services for computer programs running on the computing device 22. The computing device 22 may be loaded with a web browser 24. The web browser 24 may allow the computing device 22 to gain online access to the network 16 such as the World Wide Web. The web browser 24 may be Microsoft® Internet Explorer, Google® Chrome, Mozilla® Firefox, Apple® Safari or similar browsing applications. By connecting to the network 16, the computing device 22 may access a website 26 associated with the membership program hosted on the membership program server 12.

Alternatively, or in addition to, the computing device 22 may download a mobile application 28. The mobile application 28 may connect to the network 16 and access and communicate with the website 26 associated with the membership program hosted on the membership program server 12.

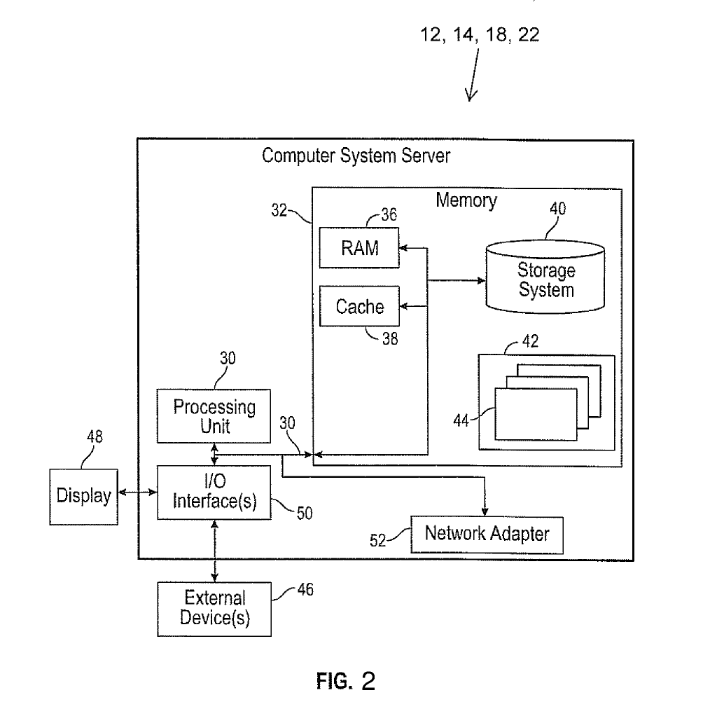

Referring now to FIG. 2, the membership program server 12, the financial service provider server 14 and the computing device 22 may be described in more detail in terms of the machine elements that provide functionality to the systems and methods disclosed herein. The components of the above mentioned devices may include, but are not limited to, one or more processors or processing units 30, a system memory 32, and a system bus 34 that couples various system components including the system memory 32 to the processor 30. The above mentioned devices may typically include a variety of computer system readable media. Such media may be chosen from any available media that is accessible by the devices, including non-transitory, volatile and non-volatile media, removable and non-removable media. The system memory 32 could include one or more computing system readable media in the form of volatile memory, such as a random access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The above mentioned devices may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the above mentioned devices to communicate with one another. Such communication may occur via Input/Output (I/O) interfaces 50. Alternatively, the above mentioned devices may communicate with one or more networks 16 (FIG. 1) such as a local area network (LAN), a general wide area network (WAN), and/or a public network via a network adapter 52. The above mentioned devices may be coupled to the one or more networks via a wired or wireless connection. As depicted, the network adapter 52 may communicate with the other components via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

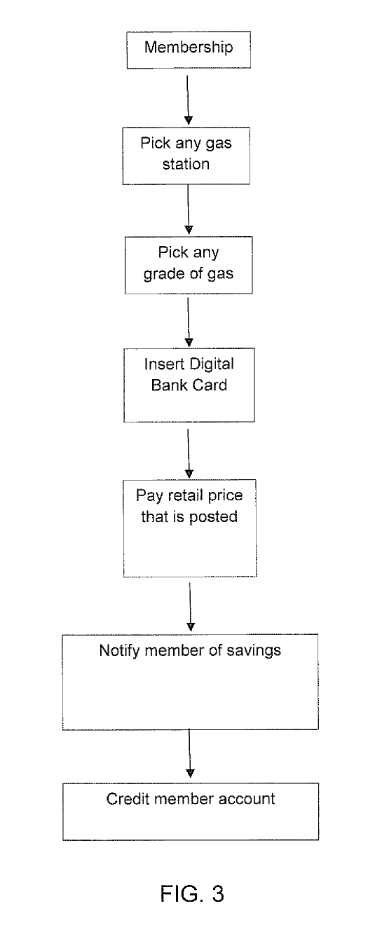

Referring now to FIGS. 1-3, operation of the system 10 in accordance with one exemplary embodiment may be seen. Operation may be disclosed as it related to the purchase of fuel such as gasoline, diesel and the like. However, the membership program may be used for the purchase of any goods/services.

To participate in the membership program, an individual 20 may need to register. To register, the individual 20 may need to access the website 26 associated with the membership program hosted on the membership program server 12. The individual 20 may access the webpage 26 or download the mobile application 28 via a computing device 22 of the individual 20. The mobile application 28 may be downloaded from iTunes®, Google Play®, Apotide® or other similar mobile application download sites. Once the individual 20 accesses the webpage 26 or opens the mobile application 28, the individual 20 may see a login screen. The login screen may have a User ID area and a password area 64.

Once the individual 20 enters the corresponding user information in the User ID area and the password area, the individual 20 may press a Login button using an external device 46 (i.e. keyboard, mouse, etc) of the computing device 22 of the individual 20. The user information may be sent to the membership program server 12 hosting the membership program for verification. If the user information of the individual 20 is verified, the individual 20 may be able to access the individual's account information. A link may be provided if the individual 20 cannot remember his/her User 1D/password. By selecting the link using an external device 46 of the computing device 22 of the individual 20, the individual 20 may be sent to reset password page and/or an email/text may be sent to the individual 20 with a temporary password.

If the individual 20 is new to the membership program, the login screen may have a link for the individual 20 to register and become a member of the membership program. By selecting the link using an external device 46 of the computing device 22 of the individual 20, the individual 20 may be sent to a registration page. The registration page 70 may have a User ID area for entering a User name of the individual 20. In accordance with one embodiment the User ID may be an email address of the individual 20. A confirmation area may be provided on the registration page for the individual to confirm the User name.

The individual 20 may be required to enter additional information. For example, information such as a bank account of the individual 20 may be needed. Information such as the age, birthday, sex, hobbies, activities and other likes/dislikes of the individual may be asked. In accordance with one embodiment, a questionnaire may be provided for the individual 20 to enter information. The questionnaire may be used to provide a detailed profile of the individual 20. The membership program server 12 may periodically resend the questionnaire to the individual 20 so that the individual 20 may update the information to more accurate define the likes/dislike of the individual 20. The individual 20 may also log into his/her personal account at any time to update the user's profile as will be described below. For example, the individual 20 may be in the market to purchase a new HDTV. The individual 20 may log into his/her personal account at any time to enter this information in the user's profile.

Once the individual 20 has registered, the individual 20 may select a membership program. A plurality of predefined membership programs may be shown to the individual 20. In accordance with one embodiment, the predefined membership programs may show a maximum number of gallons of gasoline the individual 20 may purchase per month and a membership fee. For example, 30 gallons/month @ $19.99; 40 gallons/month @ $29.99; 50 gallons/month @ 39.99; etc. The above is given as an example and should not be seen in a limiting manner. The actual number of gallons of gasoline the individual 20 may purchase per month and the membership fee may vary from the above examples without departing from the spirit and scope of the present invention. The individual 20 may adjust his/her membership selection at any time.

Once the individual 20 has registered, the individual 20 may be issued a digital bank card to the individual 20. The individual 20 may then use the digital bank card anywhere the digital bank card is accepted nationally and internationally.

When the individual 20 wishes to purchase gasoline, the individual 20 may go to any gasoline station. The user may insert the digital bank card into the pump. In accordance with one embodiment, a Personal Identification Number (PIN) may need to be entered into the pump. Once the digital bank card has been verified, the individual 20 may select a grade of gasoline and fill-up a vehicle of the individual 20. In accordance with one embodiment, the membership program server 12 and/or the financial service provider servers 14 may be used to verify the digital bank card.

When the individual 20 is finished with the purchase, the individual 20 may initially be charged the full amount of the purchase. Thus, if the grade of gasoline selected was selling at $2.00/gallon and the individual 20 purchased 15 gallons, the individual 20 may initially be charged $30.00, the full amount of the purchase. The owner of the gasoline station may be paid the full amount of the purchase. Thus, in the above example, the owner may be paid $30.00.

The individual 20 may then be notified of a savings amount based on the participation of the individual in the membership program. The notification may be through any means. For example, the individual 20 may be notified through the gasoline pump, receive a text message, receive an email, or through any other communication media. The membership program account of the individual 20 may then be credited a certain amount per gallon of gasoline purchased. In accordance with one embodiment, the membership program account of the individual 20 may then be credited 98 cents per gallon of gasoline purchased. Thus, in the above example, membership program account of the individual 20 may be credited $14.70, 15 gallows multiplied by 98 cents.

It should be noted that the membership program users are not restricted from any other promotion or discounts being offered. Thus, any discount on gasoline that has been earned participating with other promotions may be combined with the membership program to increase savings. For example, grocery store reward points as disclosed above may be used in combination with the membership program to further discount the cost of the purchase.

The membership program may recruit membership sponsors. The membership sponsors may pay a monthly fee to become a membership sponsor. The monthly fees paid by the membership sponsors may be used to offset and pay for the discounts provided to the individuals 20. Participation may allow the membership sponsors to obtain detailed information about individuals participating in the membership program based on the information entered into the questionnaire. This may allow membership sponsors to do direct marketing to individuals 20 participating in the membership program. Membership sponsors may then be able to sell products/goods to the individuals 20 thereby justifying the cost of participation.

The membership program server 12 may have a software module to match products/services being offered by membership sponsors to individuals wanting said products/services. For example, if an individual 20 indicates that he/she may be in the market for a new television, the membership program server 12 may use the software module to match the individual 20 with one or more membership sponsors having new televisions for sale.

The membership program server 12 may have a software module to allow the membership sponsors to have a website and/or advertisement area to display certain sales offers. This area may be reviewed by individuals looking for discounted products/services being offered.

In accordance with one embodiment, the system 10 may be used in conjunction with existing credit card companies such as Visa®, MasterCard®, American Express® and the like. In this embodiment, the individual 20 may register for the membership program as disclosed above. Once the individual 20 has registered and select a membership program, the individual 20 may be issued a digital bank card to the individual 20. For example, the individual 20 may be issued a Visa® Gas Member Program Card. The individual 20 may then use the Visa® Gas Member Program Card to make purchases like any other credit card. When the individual 20 wishes to purchase gasoline, the individual 20 may go to any gasoline station that accepts Visa®. The user may insert the Visa® Gas Member Program Card into the card reader of the pump. In accordance with one embodiment, a Personal Identification Number (PIN) may need to be entered into the pump. Once the Visa® Gas Member Program Card has been verified, the individual 20 may select a grade of gasoline and fill-up a vehicle of the individual 20.

When the individual 20 is finished with the purchase, the individual 20 may initially be charged the full amount of the purchase. Thus, if the grade of gasoline selected was selling at $2.00/gallon and the individual 20 purchased 15 gallons, the individual 20 may initially be charged $30.00, the full amount of the purchase. Like a regular credit card, the financial service provider server 14 may transfer funds to the gas station to cover the full purchase price of the transaction minus any processing fees. Thus, in the above example, the owner may be paid $30.00 minus any processing fees.

The individual 20 may then be notified of a savings amount based on the participation of the individual in the membership program. The notification may be through any means. For example, the individual 20 may be notified through the gasoline pump, receive a text message, receive an email, or through any other communication media. The membership program account of the individual 20 may then be credited a certain amount per gallon of gasoline purchased. In accordance with one embodiment, the membership program account of the individual 20 may then be credited 98 cents per gallon of gasoline purchased. Thus, in the above example, membership program account of the individual 20 may be credited $14.70, 15 gallows multiplied by 98 cents. In accordance with another embodiment of the Visa® Gas Member Program Card may be a cash back card. Thus, the individual 20 may be credited $14.70, 15 gallows multiplied by 98 cents for cash back at the end of a predefined term. The cash back reward may be paid by the operators of the membership program.

In accordance with one embodiment, the individual may only get a discount up to the maximum number of gallons of gasoline the individual 20 signed-up to purchase per month. Thus, for the above example, the individual 20 may only get up to 30 gallons of gasoline purchased. If the individual 20 purchases over 30 gallons, the individual 20 may have to pay the full amount and may not receive any discount from the membership program. In accordance with one embodiment, if the individual 20 thinks he/she will exceed the maximum amount, the individual 20 may upgrade to the next gallon amount (i.e., 40 gallons/month) and pay the difference in the program amount (i.e, $10 more per month).

In accordance with one embodiment, the membership program may prorate the amount credited to the account of the individual. For example, if the individual 20 purchased 10.25 gallons, the membership program may credit the account of the individual 20 $10.05 (10.25×0.98).

The membership program is a member based program that provides a discount on every gallon of gasoline the individual 20 purchases up to the maximum program amount selected by the individual 20. The membership program does not interfere with merchant pricing in any way as all discounts are paid directly to the individual 20 by the operators of the membership program and not the merchant. The membership program does not interfere with refinery pricing nor does it change and/or influence gas pricing.

The membership program is a member based program that provides a discount on every gallon of gasoline the individual 20 purchases up to the maximum program amount selected by the individual 20. The membership program does not interfere with merchant pricing in any way as all discounts are paid directly to the individual 20 by the operators of the membership program and not the merchant. Merchants are paid the full purchase price. The membership program does not interfere with refinery pricing nor does it change and/or influence gas pricing. All credits paid to the individuals 20 are covered by membership fees and fees charged to membership sponsors. Membership sponsors are provided with detailed profiles of the individuals allowing for direct marketing to the individual.

The foregoing description is illustrative of particular embodiments of the invention, but is not meant to be a limitation upon the practice thereof. The following claims, including all equivalents thereof, are intended to define the scope of the invention.

What is claimed is:

1. A method of providing a discount on fuel purchases comprising:
registering for a membership program account, the membership program account having a fee for a predetermined timeframe, the fee allowing an individual to purchase up to a maximum volume of fuel at a discounted rate for the timeframe;
issuing a bank card to the individual;
inserting the bank card in a fueling pump of a fueling station;
charging the bank card for the amount purchased; and
crediting the membership program account of the individual a predetermined amount for every gallon of fuel purchased during the timeframe that does not exceed the maximum volume, wherein the crediting is paid through the fee and membership sponsors.

2. The method of claim 1, comprising filling out a questionnaire by the individual when registering, the questionnaire providing details to allow direct marketing to the individual by membership sponsors.

3. The method of claim 1, comprising paying the fueling station the amount purchased.

4. The method of claim 1, comprising at last one of periodically resending the questionnaire to the individual and the individual logging into a personal account of the individual to update a user profile of the individual.

5. The method of claim 1, comprising one of accessing a website to register for the membership program account or downloading a mobile application to register for the membership program account.

6. The method of claim 1, comprising notifying the individual of an amount being credited.

7. The method of claim 1, comprising signing up the membership sponsors by providing the membership sponsors with detailed profiles of individuals for targeted marketing.

8. The method of claim 1, comprising signing up the membership sponsors by providing the membership sponsors with detailed profiles of individuals for targeted marketing, wherein each membership sponsor pays a fee to receive the detailed profiles.

9. The method of claim 1, comprising setting up web pages by at least one of the membership sponsors to show special offers by the membership sponsors.

10. A method of providing a discount on fuel purchases comprising:
registering for a membership program account, the membership program account having a fee for a predetermined timeframe, the fee allowing an individual to purchase up to a maximum volume of fuel at a discounted rate for the timeframe;
filling out a questionnaire by the individual, the questionnaire providing details to allow direct marketing to the individual by membership sponsors;
issuing a bank card to the individual;
inserting the bank card in a fueling pump of a fueling station;
charging the bank card for the amount purchased;
paying the fueling station the amount purchased; and
crediting the membership program account of the individual a predetermined amount for every gallon of fuel purchased during the timeframe that does not exceed the maximum volume, wherein the crediting is paid through the fee and membership sponsors.

11. The method of claim 10, comprising at last one of periodically resending the questionnaire to the individual and the individual logging into a personal account of the individual to update a user profile of the individual.

12. The method of claim 10, comprising one of accessing a website to register for the membership program account or downloading a mobile application to register for the membership program account.

13. The method of claim 10, comprising notifying the individual of an amount being credited.

14. The method of claim 10, comprising signing up the membership sponsors by providing the membership sponsors with detailed profiles of individuals for targeted marketing, wherein each membership sponsor pays a fee to receive the detailed profiles.

15. The method of claim 10, comprising setting up web pages by at least one of the membership sponsors to show special offers by the membership sponsors.

16. A method of providing a discount on fuel purchases comprising:
registering for a membership program account, the membership program account having a fee for a predetermined timeframe, the fee allowing an individual to purchase up to a maximum volume of fuel at a discounted rate for the timeframe;
filling out a questionnaire by the individual, the questionnaire providing details to allow direct marketing to the individual by membership sponsors;
signing up the membership sponsors by providing the membership sponsors with detailed profiles of individuals for targeted marketing, wherein each membership sponsor pays a fee to receive the detailed profiles;
setting up web pages by at least one of the membership sponsors to show special offers by the membership sponsors;
issuing a bank card to the individual;
inserting the bank card in a fueling pump of a fueling station;
charging the bank card for the amount purchased;
paying the fueling station the amount purchased; and
crediting the membership program account of the individual a predetermined amount for every gallon of fuel purchased during the timeframe that does not exceed the maximum volume, wherein the crediting is paid through the fee and membership sponsors.

17. The method of claim 16, comprising at last one of periodically resending the questionnaire to the individual and the individual logging into a personal account of the individual to update a user profile of the individual.

18. The method of claim 16, comprising one of accessing a website to register for the membership program account or downloading a mobile application to register for the membership program account.

19. The method of claim 16, comprising notifying the individual of an amount being credited.
